(19) United States
(12) Patent Application Publication
(10) Pub. No.: US 2004/0156513 A1
(43) Pub. Date: Aug. 12, 2004

(54) System and method for providing audio signals over conventional power lines

(75) Inventors: Robert Kaylor, Rowlett, TX (US); Sealtiel Avalos, Dallas, TX (US); Robert F. Kessler, Dallas, TX (US); Randall Muncy, Wylie, TX (US)

Correspondence Address: HAYNES AND BOONE, LLP, 901 MAIN STREET, SUITE 3100, DALLAS, TX, 75202, US

(73) Assignee: Cable Electronics, Inc., Garland, TX

(21) Appl. No.: 10/360,969

(22) Filed: Feb. 7, 2003

(51) Int. Cl. H04H 5/00; H04M 11/04

(52) U.S. Cl. 381/77; 381/16; 340/310.01

(57) ABSTRACT

The present disclosure provides a system and method for transporting audio signals over conventional power lines within a building.

### BACKGROUND OF THE INVENTION

The present disclosure relates generally to a system and method of transporting audio signals over conventional power lines found in most residences.

Conventional methods require audio signals to be transmitted via speaker wires or coax cable from the source (e.g. a CD player, a DVD player, a FM receiver, etc.) to the speaker or amplifier to be heard by a user. However, this scenario requires speaker wires or coax to be installed and is often troublesome to install within a building that is already constructed.

Therefore, what is needed, is a method to transmit audio signals from a source to an output without installing conventional speaker wires from the source to the speaker output.

### SUMMARY OF THE INVENTION

The present disclosure provides a system and method for transporting audio signals over conventional power lines.

Therefore, in accordance with the previous summary, objects, features and advantages of the present disclosure will become apparent to one skilled in the art from the subsequent description and the appended claims taken in conjunction with the accompanying drawings.

### BRIEF DESCRIPTION OF THE DRAWINGS

FIG. 1 is a schematic of the power line audio transmitter;

FIG. 2 is a schematic of the power line audio receiver;

FIG. 3 is a schematic of a FM modulator IC within the audio transmitter;

FIG. 4 is a schematic of the band pass filters within the audio transmitter;

FIG. 5 is a schematic of a passive summing circuit within the audio transmitter;

FIG. 6 is a schematic of a RF amplifier within the audio transmitter;

FIG. 7 is a schematic of a low pass filter within the audio transmitter;

FIG. 8 is a schematic of a high pass filter within the audio transmitter;

FIG. 9 is a schematic of a signal protection clamp within the audio transmitter;

FIG. 10 is a schematic of an AC line matching circuit within the audio transmitter;

FIG. 11 is a schematic of a power supply for the audio transmitter;

FIG. 12 is a schematic of a power supply for the audio receiver;

FIG. 13 is a schematic of an AC line matching circuit within the audio receiver;

FIG. 14 is a schematic of a signal protection clamp within the audio receiver;

FIG. 15 is a schematic of a high pass filter within the audio receiver;

FIG. 16 is a schematic of a low pass filter within the audio receiver;

FIG. 17 is a schematic of a set of band pass filters and an amplifier within the audio receiver;

FIG. 18 is a schematic of an FM demodulator within the audio receiver; and

FIG. 19 is a schematic of an output audio amplifier within the audio receiver.

### DETAILED DESCRIPTION OF THE PREFERRED EMBODIMENTS

The present disclosure can be described by the embodiments given below. It is understood, however, that the embodiments below are not necessarily limitations to the present disclosure, but are used to describe a typical implementation of the invention.

The system and method provides a user the ability to transmit audio signals from a source to a speaker output or amplifier without rewiring speaker wires through the walls of an existing building. The source is traditionally an Frequency Modulation (FM) receiver, a Compact Disc (CD) player, a Digital Video Disc (DVD), a computer, a Moving Picture Experts Group Layer-3 Audio (audio file format/extension) (MP3) player or some other similar type of electronic device. The system utilizes conventional power lines already existing within the building. Specifically, a transmitter and a receiver are utilized to transport the audio signals to another location within the building. The preferred embodiment can inject up to six channels of audio over the Alternating Current (AC) power line. Moreover, this embodiment utilizes FM to overcome the noise that is found in the AC lines, and thus, clear audio signals are transmitted over the AC line.

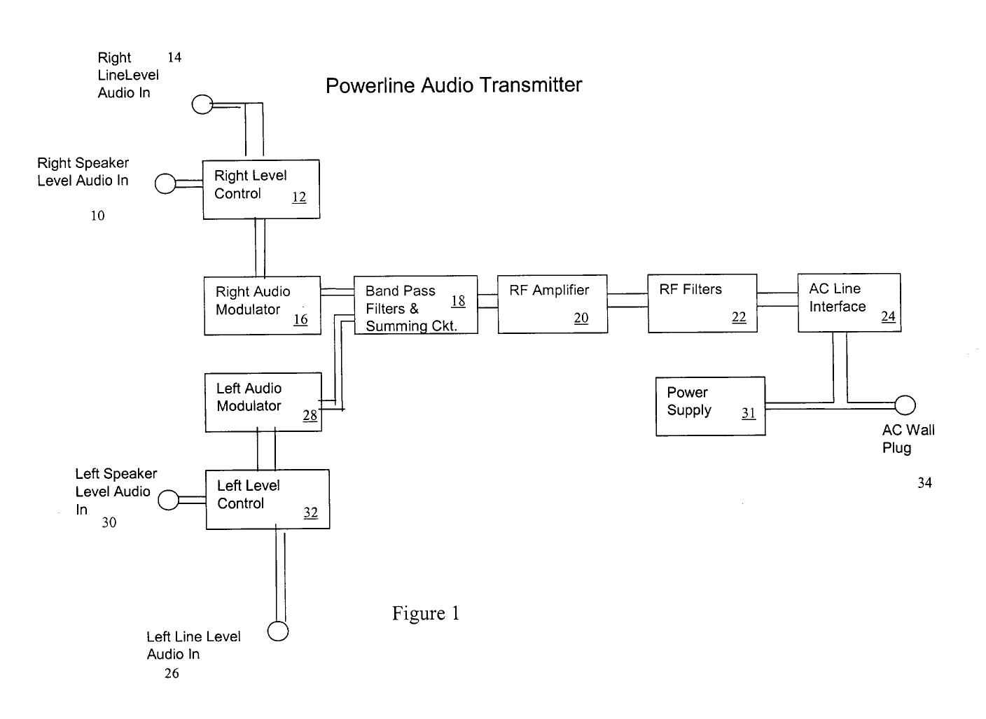

FIG. 1 is a block diagram detailing the flow of the audio signals through the audio transmitter. Specifically, a right speaker level 10 and right line level 14 audio input connects to a right level control 12. The right speaker level 10 input is attenuated to prevent overloading the modulator. The right level control 12 connects to a right audio frequency modulator 16. A left speaker level 30 and left line level 26 audio input connects to a left level control 32. The left speaker level 30 input is also attenuated to prevent overloading the modulator. The left level control 32 connects to a left audio frequency modulator 28. Generally, the frequency modulators 16 and 28 modulate the signals within the range of about 4.5 MHz to about 30 MHz. The right and left RF signals are then both transmitted to a device that includes band pass filters and a summing circuit 18. The ceramic band pass filters 18 help eliminate harmonic signals from the system. The audio receiver (not shown) also uses the same selective filters to receive the desired channels and reject the unwanted channels.

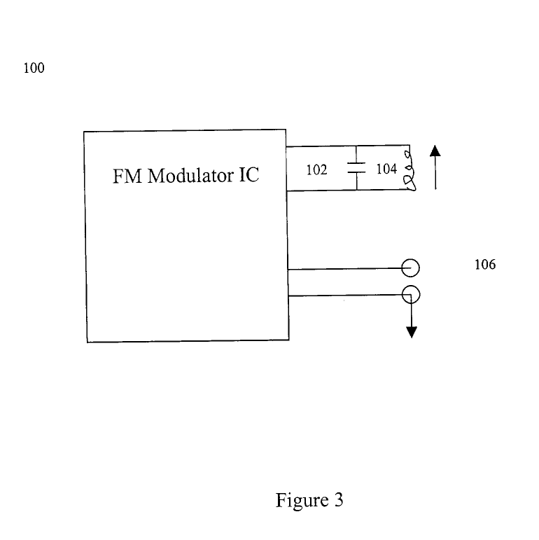

The combined signal then is transmitted to a Radio Frequency (RF) Amplifier 20, to a RF filter set 22 and then to an AC line interface 24. A power supply 31 is then combined with signals before the connection to the AC wall plug 34. More details of the transmitter is described below in reference to FIGS. 3-11.

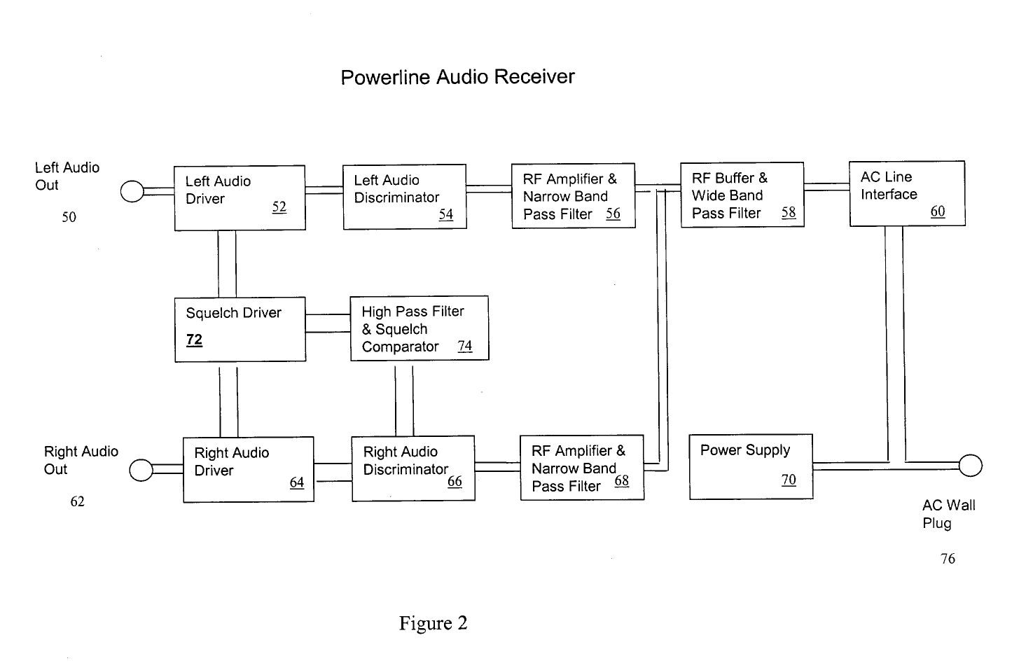

FIG. 2 is a block diagram detailing the flow of the audio signals through the audio receiver. Describing the receiver from right to left, a power supply 70 is connected to an AC line interface 60 and the AC wall plug 76. From the AC line interface 60, the signals then are transmitted to the RF Buffer and Wide Band Pass Filter device 58. From this device 58, the signals are divided and fed to the right RF Amplifier and Narrow Band Pass Filter set 56, and the left RF Amplifier and Narrow Band Pass Filter set 68. The right audio signals are then transmitted to a right audio discriminator 66 which is also connected to a High Pass Filter and Squelch Comparator 74. The right audio signals then are transmitted to the right audio driver 64 that is also connected to a Squelch Driver 72. The Squelch Driver 72 and the High Pass Filter and Squelch Comparator 74 limits the output when the power to the transmitter is turned off.

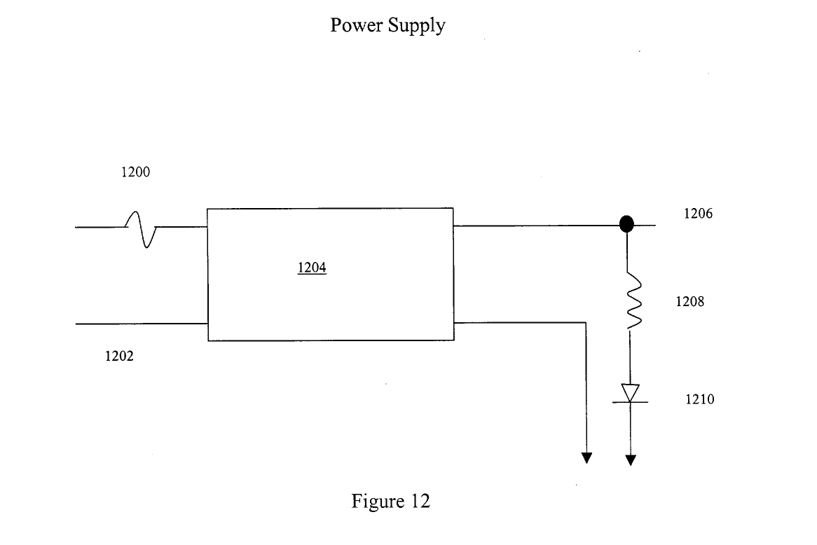

Similarly, the left audio signals are transmitted from the RF Amplifier and Narrow Band Pass Filter set 68 to a Left Audio Discriminator 54, and then to a Left Audio Driver 52. The Left Audio Driver 52 is also connected to the Squelch Driver 72. The Left Audio Output 50 as well as the Right Audio Output 62 can then be connected to amplified speakers, a computer line in, or an audio receiver (not shown) to hear the audio signals from the source. More details of the receiver is described below in reference to FIGS. 12-19.

A main part of the system is the FM modulators that work at sub-Very High Frequency (VHF) frequencies from about 5 to 30 MHz. These low frequencies are used to work with out-of-band to standard television channels. The low frequencies are also a good match to transmit over the AC power line. FIG. 3 is a block diagram of a FM modulator Integrated Circuit, indicated generally at 100, according to one embodiment. The modulator 100 includes a capacitor 102 as well as an inductor 104 and output 106.

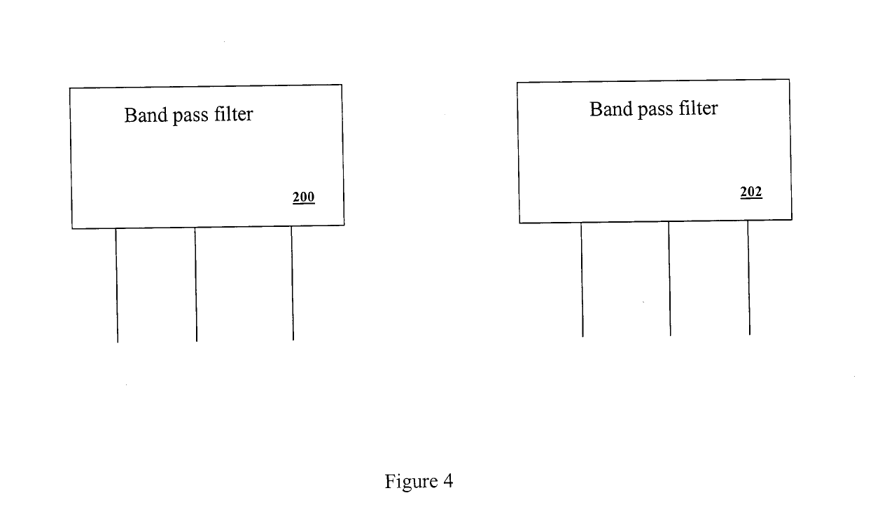

FIG. 4 shows one band pass filter 200 at a 6.0 MHz frequency and another band pass filter 202 at 5.5 MHz frequency.

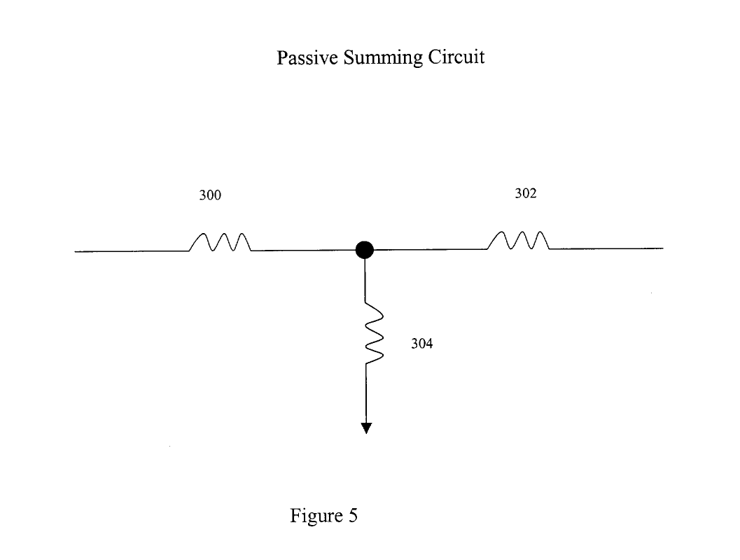

FIG. 5 illustrates a passive summing circuit. In this embodiment, the circuit includes an R34 resistor 300, an R9 resistor 302 and an R34 resistor 304. In addition, the R9 302 and the R34 resistor 304 can be selected to match RF levels.

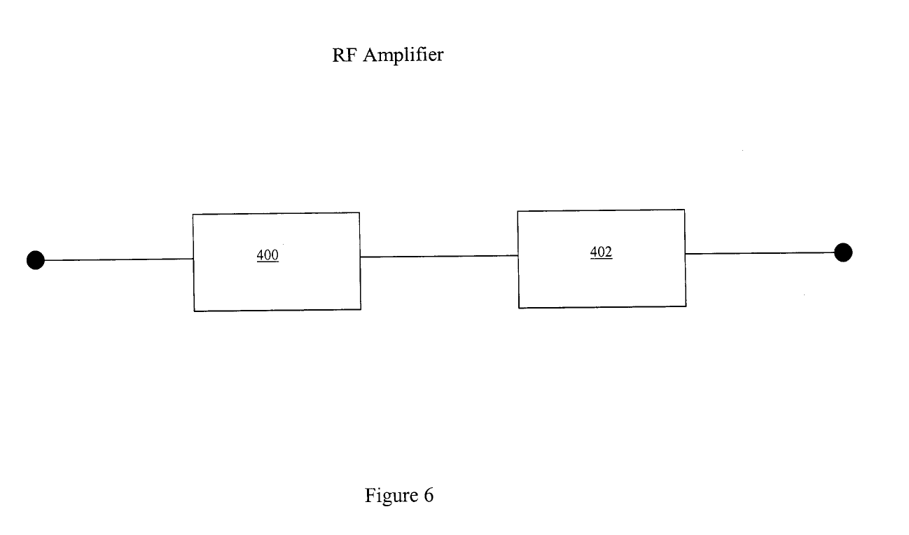

FIG. 6 illustrates an Radio Frequency (RF) amplifier with a Q1 amplifier 400 and a Q2 amplifier 402. In this embodiment, Q1 400 is a 2N3904 transistor and Q2 402 is a 2N22191 transistor.

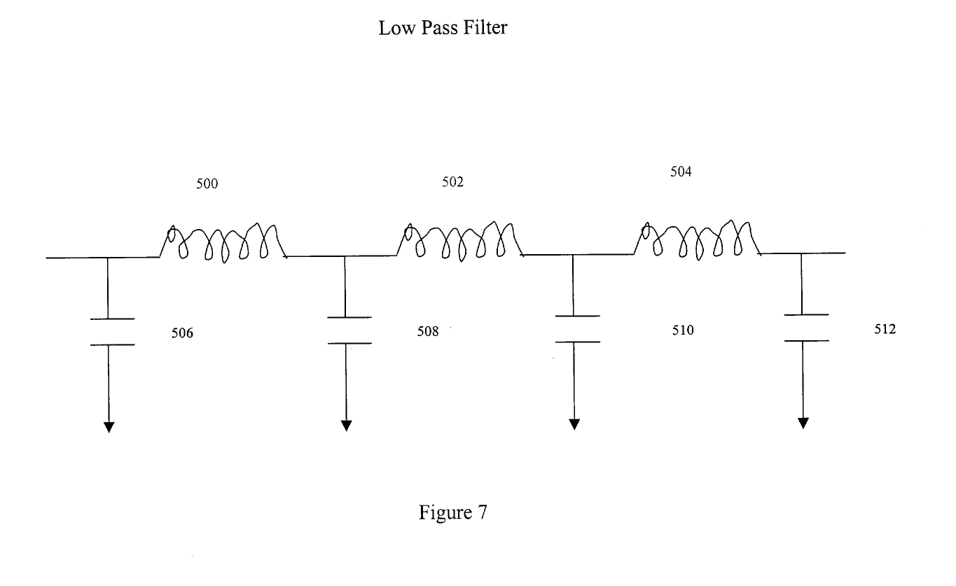

FIG. 7 illustrates a low pass filter and is made up of three inductors and four capacitors. In this embodiment, the devices have the following values: capacitor 506—220 pico farads; capacitor 508—390 pico farads; capacitor 510—390 pico farads; capacitor 512—220 pico farads; inductor 500—L2; inductor 502—L3; and inductor 504—L4. In this example, values for L1, L2, and L3 range from about 0.56 to about 3.3 micro henrys. In operation, the low pass filter serves to suppress any harmonic frequencies that might be generated by the audio modulator ICs.

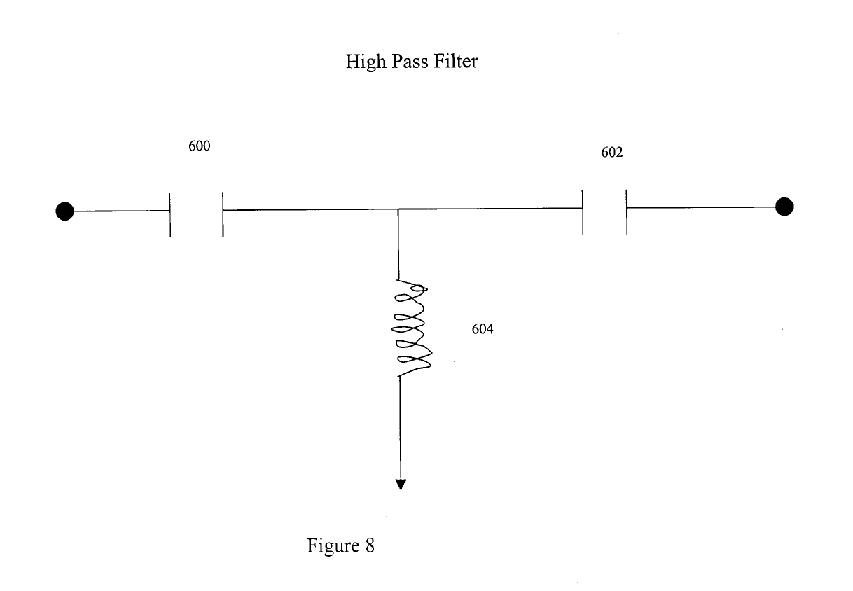

FIG. 8 illustrates a high pass filter that includes one inductor and two capacitors. The elements have values as follows: capacitor 600—0.001 micro farads; capacitor 602—0.001 micro farads; and inductor 604—10 micro henrys. This high pass filter serves to suppress the product (beat) frequency produced by the two audio modulator RF carriers. The two carriers are generally 500 kHz to 1 MHz apart.

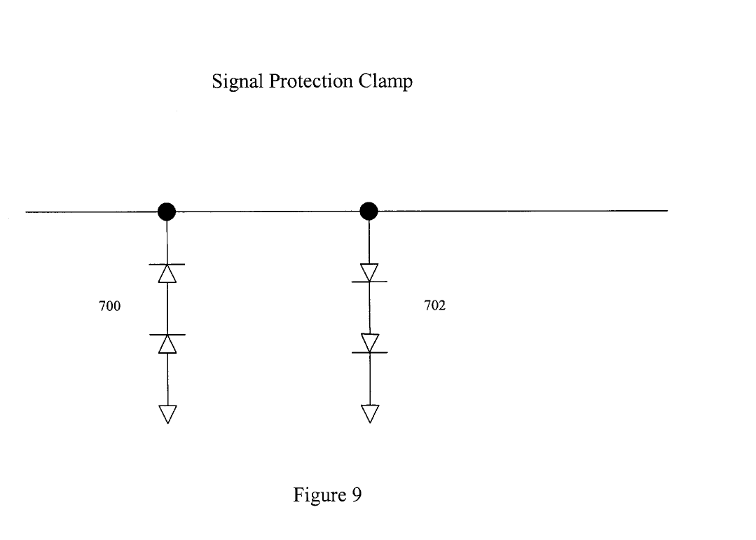

FIG. 9 illustrates a signal protection clamp. In this embodiment, the signal protection clamp includes two sets of series connected diodes 700, 702 alternately connected across the signal path. The clamp limits any spikes that return back from the AC line to approximately 1.4 volts rms. The clamp is included within the AC line interface 24 of FIG. 1.

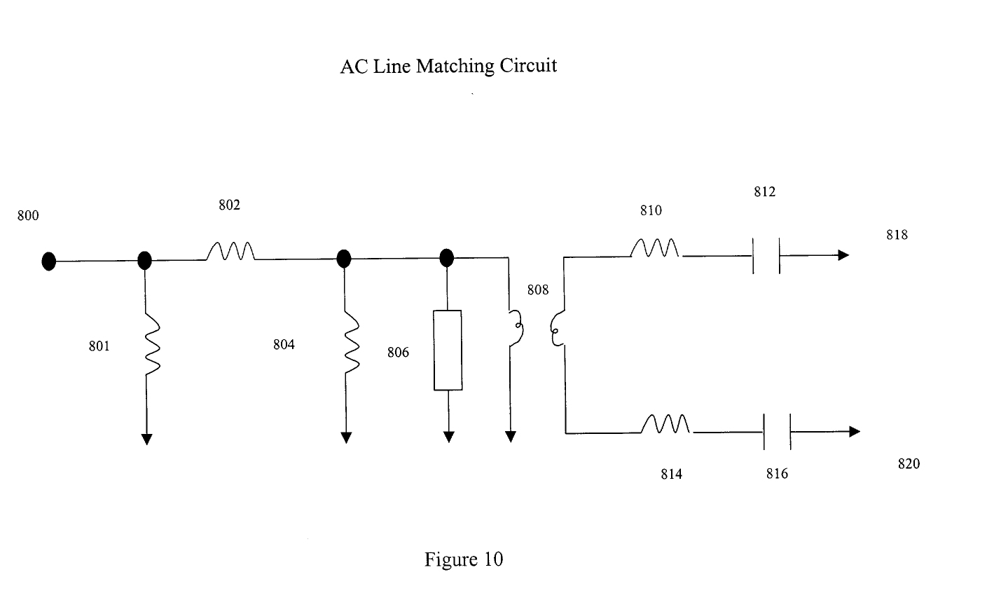

Also included in the AC Line Interface 24 of FIG. 1 is an AC line matching circuit as depicted in FIG. 10. The AC line matching circuit includes a 1 decibel (db) pad, a 1:1 balun transformer, two resistors an two capacitors to isolate the audio circuitry from the AC line. The circuit includes input line 800, resistor 801 of 2.2 k ohms, resistor 802 of 5.1 ohms, and resistor 804 of 2.2 K ohms that make up the 3 db pad. The circuit also includes the 1:1 balun transformer 808, and surge protector 806, resistor 810 of 12 ohms, resistor 814 of 12 ohms, capacitor 812 of 0.0022 micro farads, and capacitor 816 of 0.0022 micro farads. Line out 818 is hot and line out 820 is neutral in this embodiment.

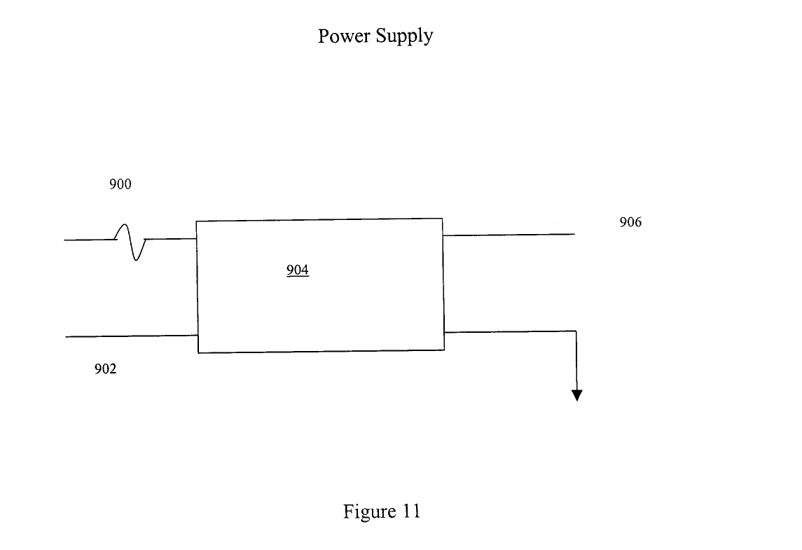

FIG. 11 illustrates a power supply that includes a 8 volt regulator 904, a full wave bridge rectifier 900, with a line in that is neutral 902, and the 8 volt output line 906. The power supply also includes filter capacitors and a power transformer as generally designated by 904.

FIGS. 12-19 illustrate specific functions and modules of the power line audio receiver depicted in FIG. 2. This embodiment of the receiver can receive two of the six channels of audio sent over the AC power line by a corresponding transmitter that is located at the other end of the system. This system receives clear audio over the AC line using FM to overcome any noise that is found on the AC line.

FIG. 12 illustrates a power supply that includes a 8 volt regulator 1204, a full wave bridge rectifier 1200, with a line in that is neutral 1202, and the 8 volt output line 1206 with a 820 ohm resistor 1208 and a power indicator 1210. The power supply also includes filter capacitors and a power transformer generally designated by 1204.

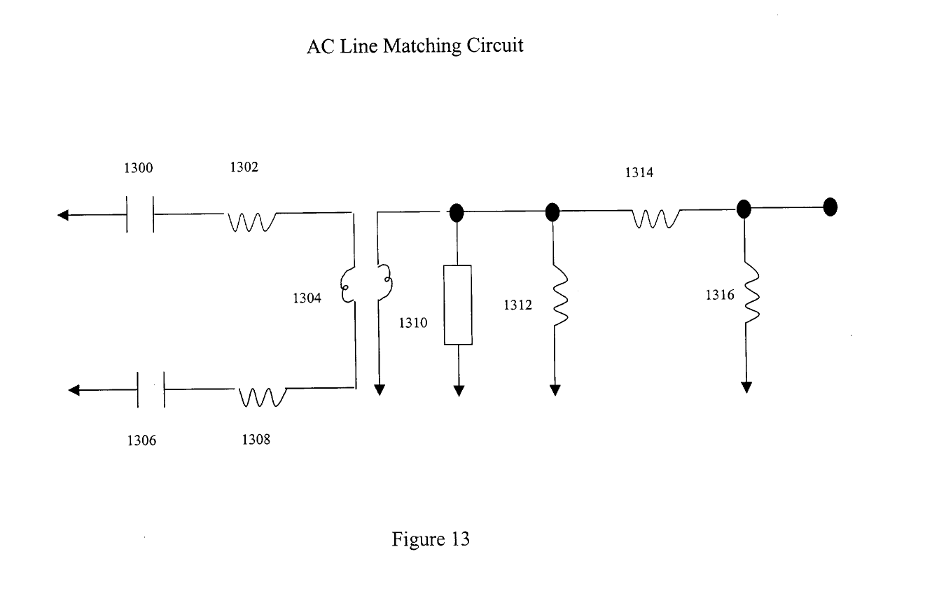

Now turning to FIG. 13, an AC power line matching circuit is illustrated. The circuit includes two isolation capacitors 1300 and 1306, each at 0.0022 micro farads and 250 Volts. The circuit also includes two resistors 1302 and 1308 at 12 ohms. A 1:1 RF balun transformer 1304 is also included with a surge arrestor 1310, and three resistors 1312, 1314 and 1316 at 2.2 k ohms, 5.1 ohms and 2.2 k ohms, respectively. The combination of the two capacitors 1300 and 1306, two resistors 1302 and 1308 and the balun transformer 1304 act as an isolation system from the 120 Volt AC line.

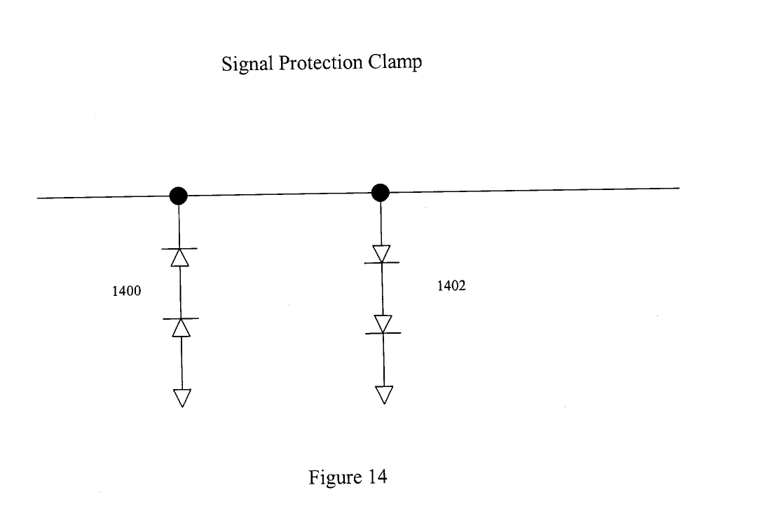

Now turning to FIG. 14, a signal protection clamp is shown. The clamp includes two sets of series connected diodes 1400 and 1402 alternately connected from the signal path to the ground. This circuit limits any spikes that might originate from the AC power line to approximately 1.4 Volts peak to peak.

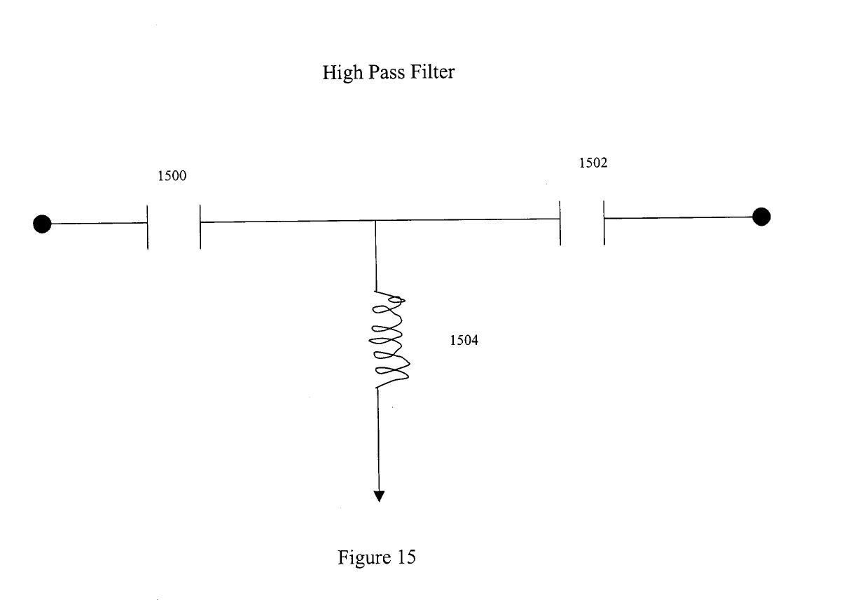

Now turning to FIG. 15, a high pass filter is illustrated. This filter includes two capacitors 1500 and 1502 each at 0.001 micro farads and an inductor 1504 at 10 micro henrys. This filter serves to isolate the receiving circuit from strong signals that might be picked up from the Amplitude Modulation (AM) radio band.

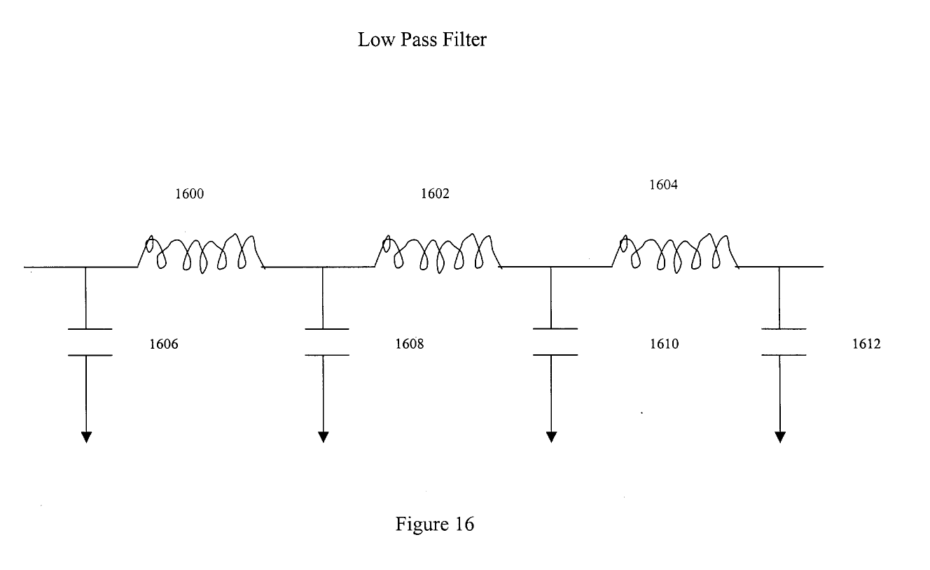

Referring now to FIG. 16, a low pass filter is illustrated. The low pass filter includes three inductors and four capacitors. In this embodiment, the devices have the following values: capacitor 1606 —220 pico farads; capacitor 1608—390 pico farads; capacitor 1610—390 pico farads; capacitor 1612—220 pico farads; inductor 1600—L2; inductor 1602—L3; and inductor 1604—L4. In this example, values for L1, L2, and L3range from 0.56 to about 3.3 micro henrys. In operation, the filter serves to pass all the desired frequencies while it suppresses any high frequencies that might interfere with the demodulator ICs.

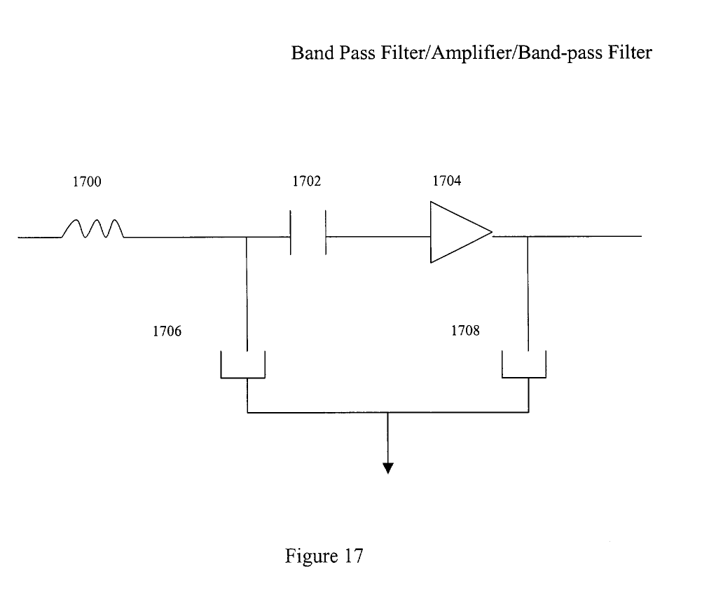

Now referring to FIG. 17, a combination of band pass filters and an amplifier is illustrated. The device includes two ceramic filters 1706 and 1708 and an amplifier 1704 and capacitor 1702 of 0.01 micro farads in between the two filters 1706 and 1708. A resistor 1700 of 100 ohms is also included. The ceramic filters 1706 and 1708 are narrow band and reject all undesired frequencies by approximately 30 db. The right and left channels each have separate frequency ceramic filters corresponding to the matching transmitter frequency. Additionally, the amplifier supplies sufficient gain to overcome any filter losses.

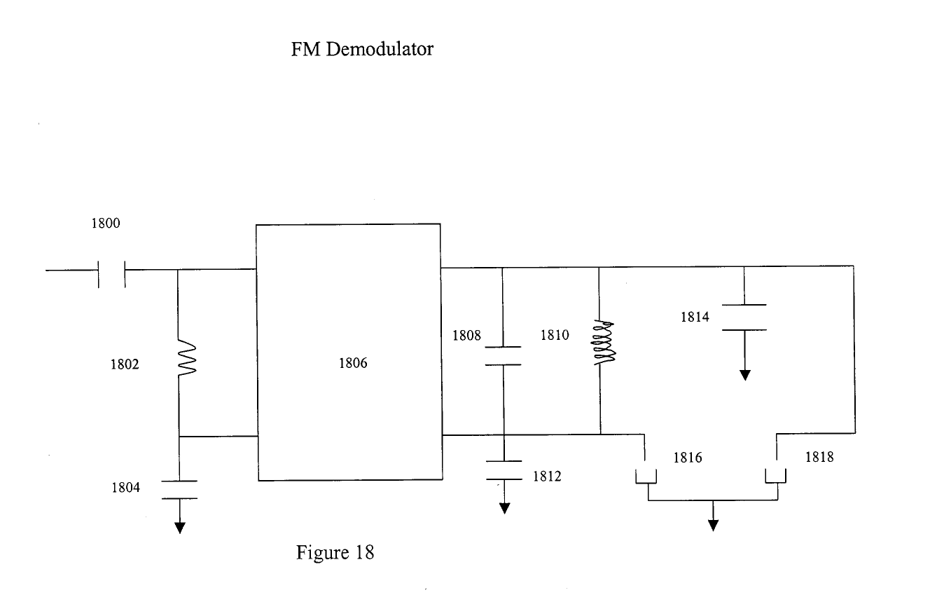

Now turning to FIG. 18, a FM demodulator is illustrated. This circuit includes a capacitor 1800 of 0.01 micro farads, a resistor 1802 of 75 ohms, a capacitor 1804 of 0.01 micro farads and a FM demodulator IC 1806 that works at sub-VHF frequencies from about 4.5 to 30 MHz. The RF signals are converted to corresponding left and right audio components. Further, these low frequencies are used to work with out of band to standard television channels. Moreover, frequencies between 5 to 30 MHz are used since they seem to have a good match to the AC power line that the signals are being transmitted on.

The circuit also includes three capacitors 1808, 1812 and 1814 at 39 pico farads, 56 pico farads, and 10 pico farads respectively. An adjustable inductor 1810 is also included that can tune the demodulator 1806 to a channel. The adjustable inductor 1810 could also be replaced by a fixed frequency ceramic resonator. Lastly, this circuit also includes two ceramic filters 1816 and 1818.

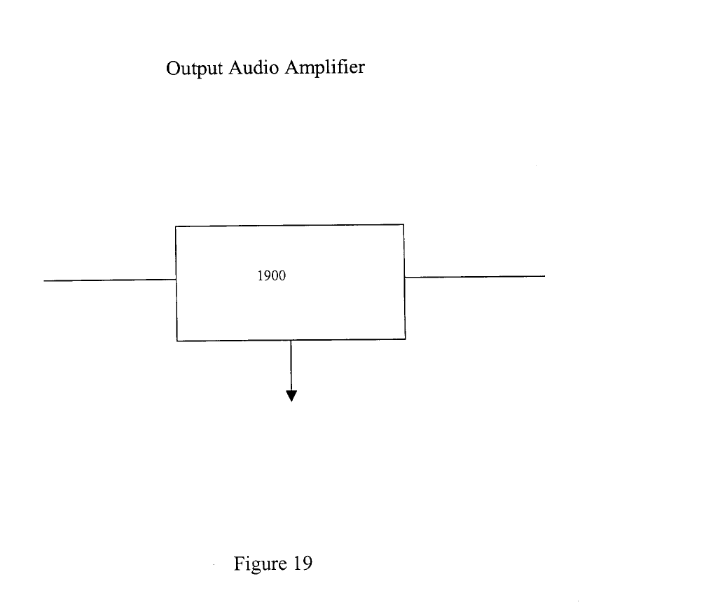

Now turning to FIG. 19, a buffer amplifier 1900 is illustrated. In the buffer amplifier circuit 1900, two transistors (not shown) per channel are utilized. The amplifier serves to isolate the demodulator IC and provides for an output impedance low enough to drive external circuits.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. An apparatus for transmitting and receiving audio signals over conventional power lines within a building, the apparatus comprising:
a right audio level control device for receiving a right speaker level and line level audio in;
a right audio modulator for receiving right audio signals from the right audio level control device;
a left audio level control device for receiving a left speaker level and line level audio in;
a left audio modulator for receiving left audio signals from the left audio level control device;
a filter and summing module for receiving signals from the right audio modulator and the left audio modulator;
an Radio Frequency (RF) amplifier for receiving signals from the filter and summing module;
a RF filter module for receiving signals from the RF amplifier;
an AC line interface for receiving signals from the RF filter module; and
a power supply connected to the AC line interface and that supplies DC power and connects to an AC circuit within the building.

2. The apparatus of claim 1 wherein the apparatus transmits audio signals from a compact disc in one room of the building to audio speakers in another room in the building.

3. The apparatus of claim 1 wherein the apparatus transmits audio signals from a FM receiver in one room of the building to speakers in another room in the building.

4. The apparatus of claim 1 wherein the audio signals transmitted are within a range of 3.5 MHz to 30 MHz.

5. The apparatus of claim 1 wherein the building is a residence.

6. The apparatus of claim 1 wherein the building is an business office.

7. An apparatus for transmitting and receiving audio signals over conventional power lines within a building, the apparatus comprising:
a right audio driver for transmitting right audio output;
a left audio driver for transmitting left audio output;
a right audio discriminator for transmitting signals to the right audio driver;
a left audio discriminator for transmitting signals to the left audio driver;
a left Radio Frequency (RF) amplifier and narrow band pass filter module for transmitting signals to the left audio discriminator;
a right RF amplifier and narrow band pass filter module for transmitting signals to the right audio discriminator;
a RF buffer and wide band filter pass module for splitting and transmitting signals to the right and the left RF amplifier modules;
an AC line interface for transmitting signals to the RF buffer and wide band filter pass module; and
a power supply connected to the AC line interface and that supplies DC power and connects to an AC circuit within the building.

8. The apparatus of claim 7 wherein the apparatus transmits audio signals from a compact disc in one room of the building to audio speakers in another room in the building.

9. The apparatus of claim 7 wherein the apparatus transmits audio signals from a FM receiver in one room of the building to speakers in another room in the building.

10. The apparatus of claim 7 wherein the audio signals transmitted are within a range of 3.5 MHz to 30 MHz.

11. The apparatus of claim 7 wherein the building is a residence.

12. The apparatus of claim 7 wherein the building is an business office.

13. An apparatus for transmitting and receiving audio signals over conventional power lines within a building, the apparatus comprising:
a power line audio transmitter, the transmitter including:
a right audio level control device for receiving a right speaker level and line level audio in;
a right audio modulator for receiving right audio signals from the right audio level control device;
a left audio level control device for receiving a left speaker level and line level audio in;
a left audio modulator for receiving left audio signals from the left audio level control device;
a filter and summing module for receiving signals from the right audio modulator and the left audio modulator;
an Radio Frequency (RF) amplifier for receiving signals from the filter and summing module;
a RF filter module for receiving signals from the RF amplifier; and
an AC line interface for receiving signals from the RF filter module; a power supply connected to the AC line interface and that supplies DC power and connects to an AC circuit within the building;
a power line audio receiver, the receiver including:
a right audio driver for transmitting right audio output;
a left audio driver for transmitting left audio output;
a right audio discriminator for transmitting signals to the right audio driver;
a left audio discriminator for transmitting signals to the left audio driver;
a left Radio Frequency (RF) amplifier and narrow band pass filter module for transmitting signals to the left audio discriminator;
a right RF amplifier and narrow band pass filter module for transmitting signals to the right audio discriminator;
a RF buffer and wide band filter pass module for splitting and transmitting signals to the right and the left RF amplifier modules;
an AC line interface for transmitting signals to the RF buffer and wide band filter pass module; and
a power supply connected to the AC line interface and that supplies DC power and connects to an AC circuit within the building.

14. The apparatus of claim 13 wherein the apparatus transmits audio signals from a compact disc in one room of the building to audio speakers in another room in the building.

15. The apparatus of claim 13 wherein the apparatus transmits audio signals from a FM receiver in one room of the building to speakers in another room in the building.

16. The apparatus of claim 13 wherein the audio signals transmitted are within a range of 3.5 MHz to 30 MHz.

17. The apparatus of claim 13 wherein the building is a residence.

18. The apparatus of claim 13 wherein the building is an business office.
